(19) United States
(12) Patent Application Publication
(10) Pub. No.: US 2025/0299623 A1
(43) Pub. Date: Sep. 25, 2025

(54) PIXEL CIRCUIT AND DISPLAY APPARATUS INCLUDING THE SAME

(71) Applicant: Samsung Display Co., LTD., Yongin-si (KR)

(72) Inventors: JOON-CHUL GOH, Yongin-si (KR); SANGHYUN HEO, Yongin-si (KR); TAEHUN LEE, Yongin-si (KR)

(21) Appl. No.: 19/004,375

(22) Filed: Dec. 29, 2024

(30) Foreign Application Priority Data
Mar. 25, 2024 (KR) 10-2024-0040684

(51) Int. Cl. G09G 3/32; G09G 3/3233

(52) U.S. Cl. CPC G09G 3/32; G09G 3/3233; G09G 2300/0819; G09G 2300/0842; G09G 2300/0861; G09G 2310/0294; G09G 2310/08; G09G 2320/045

(57) ABSTRACT

A pixel includes a first transistor which applies a driving current to a second node in response to a voltage of a first node, a second transistor which applies a data voltage to a third node, a third transistor which connects the first node and the second node to each other, a fourth transistor which connects the second node and a fourth node to each other, a fifth transistor which applies an initialization voltage to the fourth node, a sixth transistor which applies a reference voltage to the third node, a seventh transistor which applies the reference voltage to the first node, a light emitting element and a first storage capacitor including a first electrode connected to the third node and a second electrode connected to the first node.

This application claims priority to Korean Patent Application No. 10-2024-0040684, filed on March 25, and all the benefits accruing therefrom under 35 U.S.C. § 119, the content of which in its entirety is herein incorporated by reference.

### BACKGROUND

### 1. Field

Embodiments of the invention relate to a pixel circuit and display apparatus including the pixel circuit. More particularly, embodiments of the invention relate to a pixel circuit improved an integration and a display apparatus including the pixel circuit.

### 2. Description of the Related Art

Generally, a display apparatus includes a display panel and a display panel driver. The display panel may include a plurality of gate lines, a plurality of data lines, a plurality of emission lines and a plurality of pixels. The display panel driver may include a gate driver for providing a gate signal to the gate lines, a data driver for providing a data voltage to the data lines and a driving controller for controlling the gate driver, the data driver and the emission driver.

### SUMMARY

In a pixel circuit that performs an internal compensation, a reliability of a compensation voltage may be deteriorated by a body effect. Accordingly, an emitting reliability of the pixel circuit may be deteriorated.

Embodiments of the invention provide a pixel circuit with improved reliability of a compensation voltage.

Embodiments of the invention also provide a display apparatus including the pixel circuit.

According to embodiments, a pixel includes a first transistor which applies a driving current to a second node in response to a voltage of a first node, a second transistor which applies a data voltage to a third node in response to a write gate signal, a third transistor which connects the first node and the second node to each other in response to the write gate signal, a fourth transistor which connects the second node and a fourth node to each other in response to an emission signal, a fifth transistor which applies an initialization voltage to the fourth node in response to a bias gate signal, a sixth transistor which applies a reference voltage to the third node in response to an initialization gate signal, a seventh transistor which applies the reference voltage to the first node in response to a previous stage write gate signal, a light emitting element including a first electrode connected to the fourth node and a second electrode which receives a second power voltage and a first storage capacitor including a first electrode connected to the third node and a second electrode connected to the first node.

In an embodiment, the data voltage may have one of first to K-th data voltages, where K is a positive integer. In such an embodiment, a value of the reference voltage may have a value between the first data voltage and the K-th data voltage.

In an embodiment, the value of the reference voltage may have a median value between the first data voltage and the K-th data voltage.

In an embodiment, a frame period during which the pixel circuit is driven may include a data writing period, a holding period and an emitting period. In such an embodiment, in the data writing period, the write gate signal may have an activation level. In such an embodiment, in the holding period, the emission signal may have an activation level and the bias gate signal may have an activation level. In such an embodiment, in the emitting period, the emission signal may have an activation level and the bias gate signal may have an inactivation level.

In an embodiment, in the holding period, the fourth transistor may be turned on and the fifth transistor is turned on.

In an embodiment, in a first period of a frame period during which the pixel circuit is driven, the previous stage write gate signal may have an activation level, the initialization gate signal may have an activation level, the sixth transistor may be turned on and the seventh transistor may be turned on.

In an embodiment, in the first period, the bias gate signal may have an activation level and the fifth transistor may be turned on.

In an embodiment, in a second period following the first period, the write gate signal may have an activation level, and the second transistor and the third transistor may be turned on.

In an embodiment, in the second period, the activation level of the bias gate signal may be maintained and a turn-on state of the fifth transistor may be maintained.

In an embodiment, in a third period following the second period, the initialization gate signal may have an activation level and the sixth transistor may be turned on.

In an embodiment, in the third period, the bias gate signal may have an activation level and the fifth transistor may be turned on.

In an embodiment, in a fourth period following the third period, the emission signal may have an activation level, the bias gate signal may have an activation level and the fifth transistor may be turned off.

In an embodiment, the pixel circuit may further comprise a second storage capacitor. In such an embodiment, the first transistor may include a control electrode connected to the first node, a first electrode which receives a first power voltage and a second electrode connected to the second node. In such an embodiment, the second storage capacitor may include a first electrode connected to the first node and a second electrode which receives the first power voltage.

In an embodiment, the first transistor may include a control electrode connected to the first node, a first electrode which receives a first power voltage and a second electrode connected to the second node. In such an embodiment, the second transistor may include a control electrode which receives the write gate signal, a first electrode which receives the data voltage and a second electrode connected to the third node. In such an embodiment, the third transistor may include a control electrode which receives the write gate signal, a first electrode connected to the second node and the second electrode connected to the first node. In such an embodiment, the fourth transistor may include a control electrode which receives the emission signal, a first electrode connected to the second node and a second electrode connected to the fourth node. In such an embodiment, the fifth transistor may include a control electrode which receives the bias gate signal, a first electrode connected to the fourth node and a second electrode which receives the initialization voltage. In such an embodiment, the sixth transistor may include a control electrode which receives the initialization gate signal, a first electrode which receives the reference voltage and a second electrode connected to the third node. In such an embodiment, the seventh transistor may include a control electrode which receives the previous stage write gate signal, a first electrode which receives the reference voltage and a second electrode connected to the first node.

According to embodiments, a pixel circuit includes a first transistor which applies a driving current to a second node in response to a voltage of a first node, a second transistor which applies a data voltage to a third node in response to a write gate signal, a third transistor which connects the first node and the second node to each other in response to the write gate signal, a fourth transistor which connects the second node and a fourth node to each other in response to an emission signal, a fifth transistor which applies an initialization voltage to the fourth node in response to a bias gate signal, a sixth transistor which applies a reference voltage to the third node in response to an initialization gate signal, a seventh transistor which applies the reference voltage to the first node in response to a control gate signal, a light emitting element including a first electrode connected to the fourth node and a second electrode which receives a second power voltage and a first storage capacitor including a first electrode connected to the third node and a second electrode connected to the first node.

In an embodiment, the data voltage may have one of first to K-th data voltages, where K is a positive integer. In such an embodiment, a value of the reference voltage may have a value between the first data voltage and the K-th data voltage.

In an embodiment, the value of the reference voltage may have a median value between the first data voltage and the K-th data voltage.

In an embodiment, a frame period during which the pixel circuit is driven may include a data writing period, a holding period and an emitting period. In such an embodiment, in the data writing period, the write gate signal may have an activation level. In such an embodiment, in the holding period, the emission signal may have an activation level and the bias gate signal may have an activation level. In such an embodiment, in the emitting period, the emission signal may have an activation level and the bias gate signal may have an inactivation level.

According to embodiments, a display apparatus includes a display panel including a pixel circuit, a gate driver which outputs a write gate signal, a previous stage write gate signal, an initialization gate signal and a bias gate signal to the pixel circuit, a data driver which applies a data voltage to the display panel and an emission driver which applies an emission signal to the pixel circuit. In such embodiments, the pixel circuit includes a first transistor which applies a driving current to a second node in response to a voltage of a first node, a second transistor which applies a data voltage to a third node in response to a write gate signal, a third transistor which connects the first node and the second node to each other in response to the write gate signal, a fourth transistor which connects the second node and a fourth node to each other in response to an emission signal, a fifth transistor which applies an initialization voltage to the fourth node in response to a bias gate signal, a sixth transistor which applies a reference voltage to the third node in response to an initialization gate signal, a seventh transistor which applies the reference voltage to the first node in response to a previous stage write gate signal, a light emitting element including a first electrode connected to the fourth node and a second electrode which receives a second power voltage and a first storage capacitor including a first electrode connected to the third node and a second electrode connected to the first node.

In an embodiment, the data voltage may have one of first to K-th data voltages, where K is a positive integer. In such an embodiment, a value of the reference voltage may have a value between the first data voltage and the K-th data voltage.

In an embodiment, the value of the reference voltage may have a median value between the first data voltage and the K-th data voltage.

In an embodiment, a frame period during which the pixel circuit is driven may include a data writing period, a holding period and an emitting period. In such an embodiment, in the data writing period, the write gate signal may have an activation level. In such an embodiment, in the holding period, the emission signal may have an activation level and the bias gate signal may have an activation level. In such an embodiment, in the emitting period, the emission signal may have an activation level and the bias gate signal may have an inactivation level.

In an embodiment, a frame period during which the pixel circuit is driven includes a first period, a second period, a third period and a fourth period. In such an embodiment, in the first period, the bias gate signal may have an activation level, the emission signal may have an inactivation level, the previous stage write gate signal may have an activation level, the initialization gate signal may have an activation level and the write gate signal may have an inactivation level. In such an embodiment, in the second period, the bias gate signal may have an activation level, the emission signal may have an inactivation level, the previous stage write gate signal may have an inactivation level, the initialization gate signal may have an inactivation level and the write gate signal may have an activation level. In such an embodiment, in the third period, the bias gate signal may have an activation level, the emission signal may have an activation level, the previous stage write gate signal may have an inactivation level, the initialization gate signal may have an activation level and the write gate signal may have an inactivation level. In such an embodiment, in the fourth period, the bias gate signal may have an inactivation level, the emission signal may have an activation level, the previous stage write gate signal may have an inactivation level, the initialization gate signal may have an activation level and the write gate signal may have an inactivation level.

In an embodiment, the pixel circuit may be disposed on a silicon-based substrate.

As described above, according to embodiments of the pixel circuit and the display apparatus including the pixel circuit, the data voltage may not be applied through the source electrode of the first transistor. In such embodiments, the source electrode of the first transistor may only receive the first power voltage. Accordingly, a voltage applied to the source electrode of the first transistor may not be changed. In such embodiments, the voltage applied to the source electrode of the first transistor may not be changed, such that a change of the threshold voltage of the first transistor by a body effect may not occur. Additionally, the threshold voltage of the first transistor may be substantially constant during the frame period. Accordingly, the accuracy of the compensation voltage may be improved, such that the driving reliability and the emitting reliability may be further improved.

Additionally, the reference voltage applied to the pixel circuit may be higher than the first data voltage and may be lower than the K-th data voltage. For example, the reference voltage may have a value between the first data voltage and the K-th data voltage. Accordingly, a storage voltage which is a voltage between the first electrode and the second electrode of the storage capacitor may be decreased.

Additionally, the frame period during which the pixel circuit is driven may include a holding period. In the holding period, a current may flow along a path through a driving transistor, an emission transistor and an initialization transistor. Accordingly, the influence of the parasitic capacitance in the emitting period may be reduced. For example, when the pixel circuit operates to display black, the influence of the parasitic capacitance is reduced, such that the light emitting element may not emit light. Accordingly, the emitting reliability of the pixel circuit may be improved such that the display quality of the display panel may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display apparatus according to embodiments of the invention.

FIG. 2 is a schematic cross-sectional view of an example of a pixel transistor included in a pixel circuit of display apparatus of FIG. 1.

FIG. 3 is a circuit diagram illustrating an example of a pixel circuit included in a display apparatus of FIG. 1.

FIG. 4 is a signal timing diagram illustrating input signals applied to the pixel circuit of FIG. 3.

FIG. 5 is a circuit diagram illustrating an operation of a pixel circuit of FIG. 3 in a first period of FIG. 4.

FIG. 6 is a circuit diagram illustrating an operation of a pixel circuit of FIG. 3 in a second period of FIG. 4.

FIG. 7 is a circuit diagram illustrating an operation of a pixel circuit of FIG. 3 in a third period of FIG. 4.

FIG. 8 is a circuit diagram illustrating an operation of a pixel circuit of FIG. 3 in a fourth period of FIG. 4.

FIG. 9 is a circuit diagram illustrating an example of a pixel included in a display apparatus of FIG. 1.

FIG. 10 is a schematic cross-sectional view of an example of a storage capacitor included in a pixel circuit of FIG. 9.

FIG. 11 is a schematic plan view of an example of a storage capacitor included in a pixel circuit of FIG. 9.

FIG. 12 is a circuit diagram illustrating an example of a pixel circuit included in a display apparatus of FIG. 1.

FIG. 13 is a signal timing diagram illustrating input signals applied to a pixel circuit of FIG. 12.

FIG. 14 is a circuit diagram illustrating an example of a pixel circuit included in a display apparatus of FIG. 1.

FIG. 15 is a diagram illustrating an example of pixel circuit of FIG. 1 disposed on a substrate.

FIG. 16 is a block diagram illustrating an electronic device according to an embodiment of the invention.

FIG. 17 is a diagram illustrating an example in which the electronic device of FIG. 16 is implemented as a smart phone.

FIG. 18 is a diagram illustrating an example in which the electronic apparatus of FIG. 16 is implemented as a virtual reality display system.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

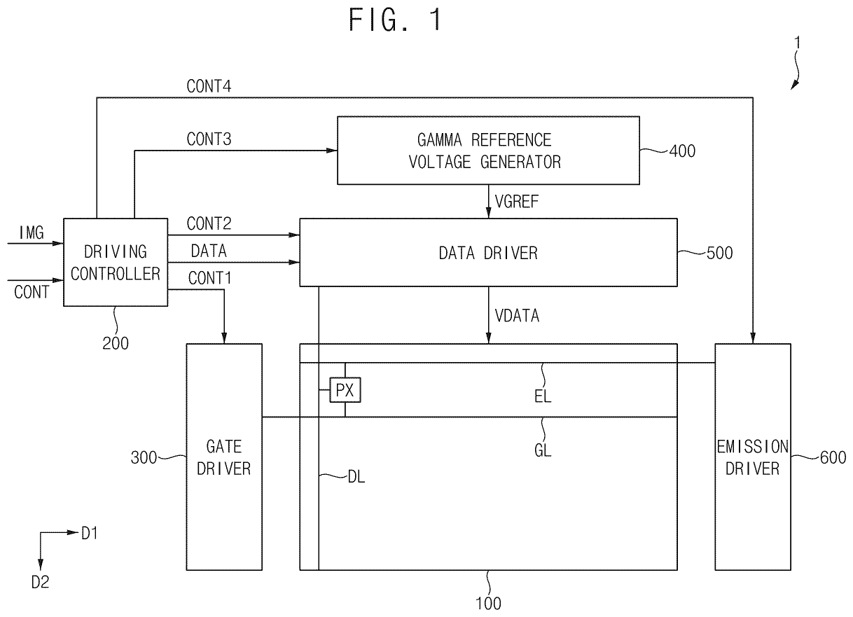

FIG. 1 is a block diagram illustrating a display apparatus 1 according to embodiments of the invention.

Referring to FIG. 1, an embodiment of the display apparatus 1 includes a display panel 100 and a display panel driver. The display panel driver includes a driving controller 200, a gate driver 300, a gamma reference voltage generator 400, a data driver 500 and an emission driver 600.

The display panel 100 includes a display region on which an image is displayed and a peripheral region adjacent to the display region.

In an embodiment, the display panel 100 includes a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 receives input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

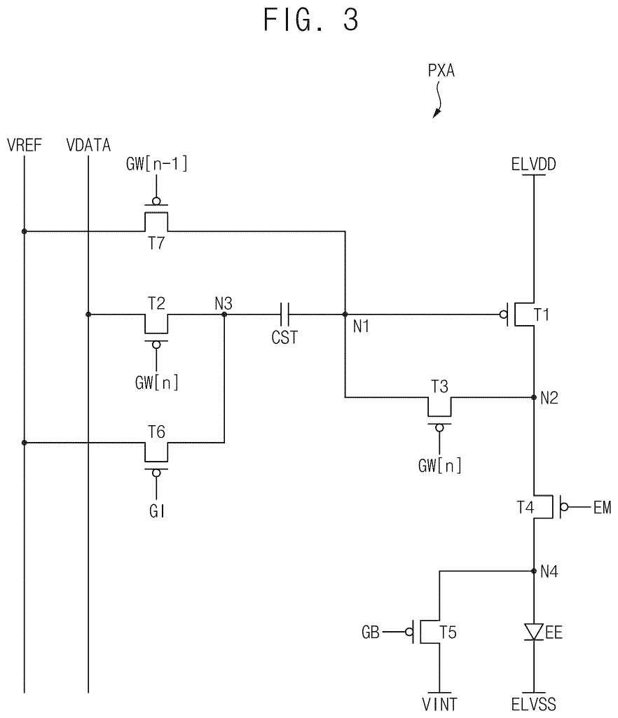

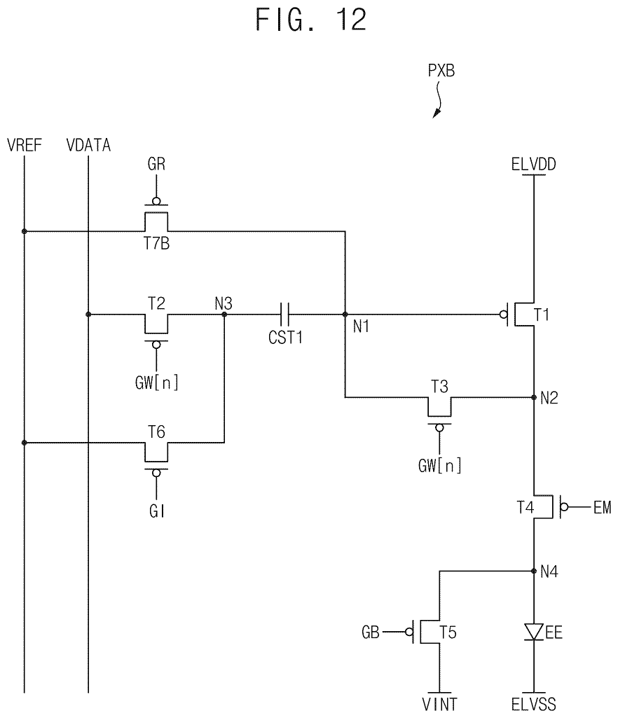

The gate driver 300 generates gate signals driving the gate lines GL in response to the first control signal CONT1 received from the driving controller 200. The gate driver 300 may output the gate signals to the gate lines GL. In an embodiment, for example, the gate signals may include an initialization gate signal GI of FIG. 3, a write gate signal GW[n] (i.e., a write gate signal generated from a current stage among a plurality of stages in the gate driver 300) of FIG. 3, a previous stage write gate signal GW[n−1] (i.e., a write gate signal generated from a previous stage among the plurality of stages in the gate driver 300) of FIG. 3, a bias gate signal GB of FIG. 3 and a control gate signal GR of FIG. 12.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL. The data voltages VDATA may include a first data voltage and a K-th data voltage. Herein, K is a positive integer. The data voltages VDATA may have one of the first to K-th data voltages respectively corresponding to grayscales of images to be display by the display panel 100. In an embodiment, for example, the first data voltage may be a voltage such that the pixel circuit PX emits light as zero (0) grayscale. In an embodiment, for example, the K-th data voltage may be a voltage such that the pixel circuit PX emits light as 255 grayscale. However, the invention is not limited to a grayscale that the pixel circuit PX emits.

The emission driver 600 may generate emission signal EM of FIG. 3 in response to the fourth control signal CONT4 received from the driving controller 200. The emission driver 600 may output the emission signal EM of FIG. 3 to the display panel 100.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of illustration and description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other as a single chip.

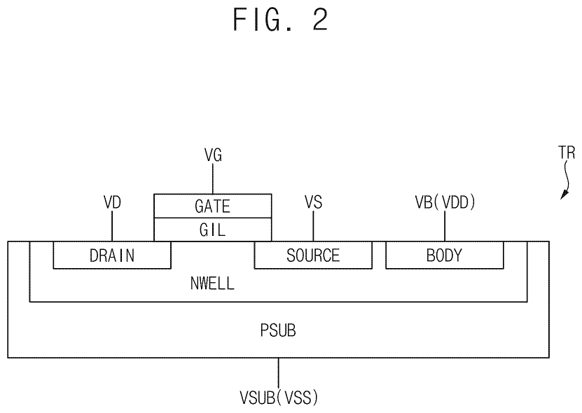

FIG. 2 is a schematic cross-sectional view of an example of a pixel transistor TR included in a pixel circuit PX of display apparatus 1 of FIG. 1.

Referring to FIG. 1 and FIG. 2, in an embodiment, a substrate (or a pixel substrate) PSUB may be a silicon substrate. In an embodiment, for example, the substrate PSUB may be a p-type silicon substrate. The substrate PSUB may include a well region NWELL. The well region NWELL may be an N-well. Here, P may refer to a hole, and N may refer to an electron. The substrate PSUB may receive a substrate voltage VSUB. In an embodiment, for example, a substrate voltage VSUB may be a low power voltage VSS. In an embodiment, for example, the substrate voltage VSUB may be a lowest voltage which the pixel circuit PX may receive.

The substrate SUB may include a source region SOURCE, a drain region DRAIN and a body region BODY. In an embodiment, for example, the source region SOURCE may be a P-source region. In an embodiment, for example, the drain region DRAIN may be a P-drain region. In an embodiment, for example, the body region BODY may be an N-body region. In an embodiment, for example, the source region SOURCE may receive a source voltage VS. The drain region DRAIN may receive a drain voltage VD. The body region VODY may receive a body voltage VD. In an embodiment, for example, when the pixel transistor TR is a P-type transistor, the body voltage VB may be a high power voltage VDD higher than the low power voltage VSS. In an embodiment, for example, the body voltage VB may be a highest voltage which the pixel circuit PX may receive.

When the pixel transistor TR operates, the source voltage VS may be decreased. When the source voltage VS is decreased, an absolute value of a threshold voltage of the pixel transistor TR may be changed. For example, the absolute value of the threshold voltage of the pixel transistor TR may be changed by a body effect. For example, the absolute value of the threshold voltage of the pixel transistor TR may satisfy Equation 1 below.

$$\vert {V}_{th} \vert = \vert {V}_{th 0} \vert + r ( \sqrt{2 sp - {V}_{SB}} - \sqrt{2 sp} ) \qquad [ Equation 1 ]$$

In Equation 1, Vth denotes a threshold voltage after change, Vth0 denotes a threshold voltage before change, r denotes a body effect coefficient, sp denotes a surface potential of the well region NWELL, and VSB denotes a difference between the source voltage VS and the body voltage VB.

In an embodiment, for example, where the pixel transistor TR is a P-type transistor and the source voltage VS is decreased, the absolute value of the threshold voltage of the pixel transistor TR may be increased.

When a data writing operation is performed in a conventional pixel circuit, a reliability of the data writing operation is deteriorated by the body effect. For example, in the conventional pixel circuit, a conventional compensation voltage considering a threshold voltage after the change due to the body effect may be stored in a conventional storage capacitor. Accordingly, the conventional pixel circuit may emit light based on the conventional compensation voltage, so that a driving reliability may be deteriorated.

A gate insulating layer GIL may be disposed on the substrate PSUB. The insulating layer GIL may include an inorganic material, such as silicon oxide (SiOx), silicon nitride (SiNx), silicon carbide (SiCx), silicon oxynitride (SiOxNy), silicon oxycarbide (SiOxCy), or the like. These materials may be used alone or in a suitable combination with each other.

A gate electrode GATE may be disposed on the gate insulating layer GIL. The gate electrode GATE may include a metal, an alloy metal nitride, a conductive metal oxide, a transparent conductive material, or the like. Examples of the metal may include silver (Ag), molybdenum (Mo), aluminum (Al), tungsten (W), copper (Cu), nickel (Ni), chromium (Cr), titanium (Ti), tantalum (Ta), platinum (Pt), scandium (Sc), or the like. Additionally, examples of the conductive metal oxide may include Indium tin oxide, indium zinc oxide, or the like. Additionally, examples of the metal nitride may include aluminum nitride (AlNx), tungsten nitride (WNx), chromium nitride (CrNx), or the like.

FIG. 3 is a circuit diagram illustrating an example of a pixel circuit PX included in a display apparatus 1 of FIG. 1.

Referring to FIG. 1 to FIG. 3, an embodiment of the pixel circuit PXA may include a first transistor T1, a second transistor T2, a third transistor T3, a fourth transistor T4, a fifth transistor T5, a sixth transistor T6, a seventh transistor T7, a storage capacitor CST and a light emitting element EE.

The first transistor T1 may include a control electrode connected to a first node N1, a first electrode that receives a first power voltage ELVDD and a second electrode connected to a second node N2. The first transistor T1 may generate a driving current based on a voltage of the first node N1. The first transistor T1 may apply the driving current to the second node N2 in response to the voltage of the first node N1. For example, the first transistor T1 may be called as a driving transistor.

The second transistor T2 may include a control electrode that receives a write gate signal GW[n], a first electrode that receives the data voltage VDATA and a second electrode connected to a third node N3. The second transistor T2 may apply the data voltage VDATA to the third node N3 in response to the write gate signal GW[n]. For example, the second transistor T2 may be called as a write transistor.

The third transistor T3 may include a control electrode that receives the write gate signal GW[n], a first electrode connected to the second node N2 and a second electrode connected to the first node N1. The third transistor T3 may connect the first node N1 and the second node N2 to each other in response to the write gate signal GW[n]. The third transistor T3 may be diode-connecting the first transistor T1 in response to the write gate signal GW[n]. For example, the third transistor T3 may be called as a compensation transistor.

The fourth transistor T4 may include a control electrode that receives the emission signal EM, a first electrode connected to the second node N2 and a second electrode connected to a fourth node N4. The fourth transistor T4 may connect the second node N2 and the fourth node N4 to each other in response to the emission signal EM. The fourth transistor T4 may apply the driving current to the fourth node N4 in response to the emission signal EM. For example, the fourth transistor T4 may be called as an emission transistor.

The fifth transistor T5 may include a control electrode that receives the bias gate signal GB, a first electrode connected to the fourth node N4 and a second electrode that receives an initialization voltage VINT. For example, the fifth transistor may be called as a first initialization transistor.

In an embodiment, the initialization voltage VINT may be lower than a second power voltage ELVSS. In an embodiment, for example, the initialization voltage VINT may be lower than a value obtained by subtracting the absolute value of the threshold voltage of the fifth transistor T5 from the value obtained by adding the second power voltage ELVSS and the threshold voltage of the light emitting element EE. Accordingly, when the initialization voltage VINT is applied to the fourth node N4, the light emitting element EE may not emits light. In an embodiment, for example, when the initialization voltage VINT is applied to the fourth node N4, the pixel circuit PXA may display black. The initialization voltage VINT may be lower than the second power voltage ELVSS, such that a black characteristic of the pixel circuit PXA may be improved.

Additionally, the initialization voltage VINT may be the lowest voltage which the pixel circuit PXA may receive. Accordingly, the initialization voltage VINT may be substantially the same as the substrate voltage VSUB.

The sixth transistor T6 may include a control electrode that receives the initialization gate signal GI, a first electrode that receives a reference voltage VREF and a second electrode connected to the third node N3. The sixth transistor T6 may apply the reference voltage VREF to the third node N3 in response to the initialization gate signal GI. For example, the sixth transistor T6 may be called as a second initialization transistor.

In an embodiment, the reference voltage VREF may be higher than the first data voltage and may be lower than the K-th data voltage. In an embodiment, for example, the reference voltage VREF may have a value between the first data voltage and the K-th data voltage. In an embodiment, value of the reference voltage VREF may have a median value between the first data voltage and the K-th data voltage. Accordingly, a storage voltage VST of FIG. 9, which is a voltage between the first electrode and the second electrode of the storage capacitor CST, may be decreased.

The seventh transistor T7 may include a control electrode that receives the previous stage gate signal GW[n−1], a first electrode that receives the reference voltage VREF and the second electrode connected to the first node N1. The seventh transistor T7 may apply the reference voltage VREF to the first node N1 in response to the previous stage write gate signal GW[n−1]. For example, the seventh transistor T7 may be called as a third initialization transistor.

The storage capacitor CST may include a first electrode connected to the third node N3 and a second electrode connected to the first node N1. The storage capacitor CST may store a difference between a voltage of the first node N1 and a voltage of the third node N3. The storage capacitor CST may be coupling a change of the voltage of the third node N3 and apply a coupling voltage to the first node N1. For example, the storage capacitor CST may be called as a first storage capacitor.

The light emitting element EE may include a first electrode connected to the fourth node N4 and the second electrode that receives the second power voltage ELVSS. In an embodiment, the light emitting element EE may include an organic light emitting diode (OLED), a nano light emitting diode (NED), a quantum dot (QD) light emitting diode, a micro light emitting diode, an inorganic light emitting diode, or any other suitable light emitting element.

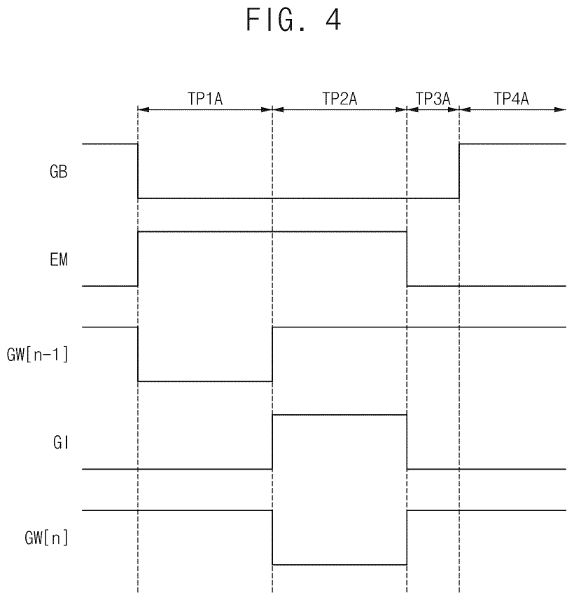

FIG. 4 is a signal timing diagram illustrating input signals applied to the pixel circuit PXA of FIG. 3.

Referring to FIG. 1 to FIG. 4, a frame period during which the pixel circuit PXA is driven may include a first period TP1A, a second period TP2A, a third period TP3A and a fourth period TP4A.

In the first period TP1A, the bias gate signal GB may have an activation level, the emission signal EM may have an inactivation level, the previous stage gate signal GW[n−1] may have an activation level, the initialization gate signal GI may have an activation level and the write gate signal GW[n] may have an inactivation level. For example, the first period TP1A may be called as an initialization period.

In the second period TP2A, the bias gate signal GB may have an activation level, the emission signal EM may have an inactivation level, the previous stage gate signal GW[n−1] may have an inactivation level, the initialization gate signal GI may have an inactivation level and the write gate signal GW[n] may have an inactivation level. For example, the second period TP2A may be called as a data writing period.

In the third period TP3A, the bias gate signal GB may have an activation level, the emission signal EM may have an activation level, the previous stage gate signal GW[n−1] may have an inactivation level, the initialization gate signal GI may have an activation level and the write gate signal GW[n] may have an inactivation level. For example, the third period TP3A may be called as a holding period.

In the fourth period TP4A, the bias gate signal GB may have an inactivation level, the emission signal EM may have an activation level, the previous stage gate signal GW[n−1] may have an inactivation level, the initialization gate signal GI may have an activation level and the write gate signal GW[n] may have an inactivation level. For example, the fourth period TP4A may be called as an emitting period.

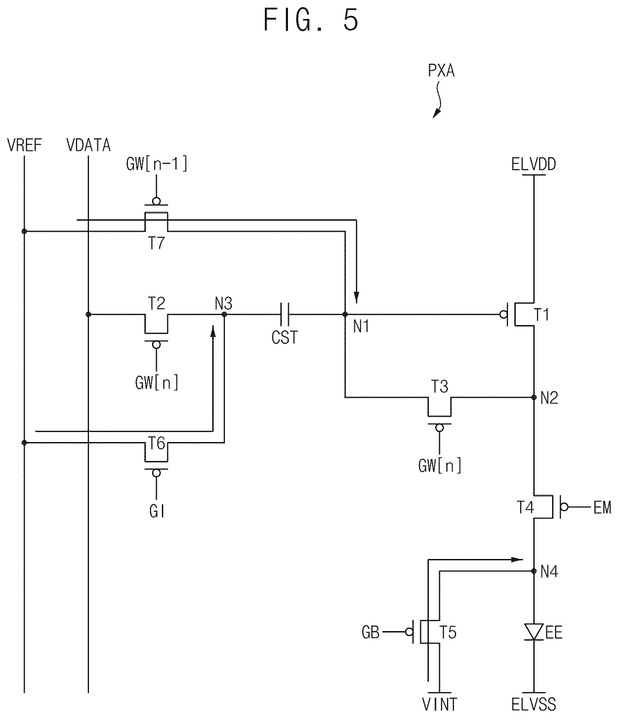

FIG. 5 is a circuit diagram illustrating an operation of a pixel circuit PXA of FIG. 3 in a first period TP1A of FIG. 4.

Referring to FIG. 4 and FIG. 5, in the first period TP1A, the sixth transistor T6 may be turned on based on the initialization gate signal GI having the activation level. When the sixth transistor T6 is turned on, the reference voltage VREF may be applied to the third node N3. The seventh transistor T7 may be turned on in response to the previous stage write gate signal GW[n−1]. When the seventh transistor T7 is turned on, the reference voltage VREF may be applied to the first node N1. Accordingly, the first node N1 may be initialized as the reference voltage VREF, and the third node N3 may be initialized as the reference voltage VREF. When the first node N1 receives the reference voltage VREF and the third node N3 receives the reference voltage VREF, a voltage of the first node N1 and a voltage of the third node N3 may be substantially the same as each other. Accordingly, the storage capacitor CST may be initialized.

In the first period TP1A, the first transistor T1 may be turned on in response to a voltage of the first node N1.

In the first period TP1A, the fifth transistor T5 may be turned on in response to the bias gate signal GB. When the fifth transistor T5 is turned on, the initialization voltage VINT may be applied to the fourth node N4, such that the light emitting element EE may stop emitting light.

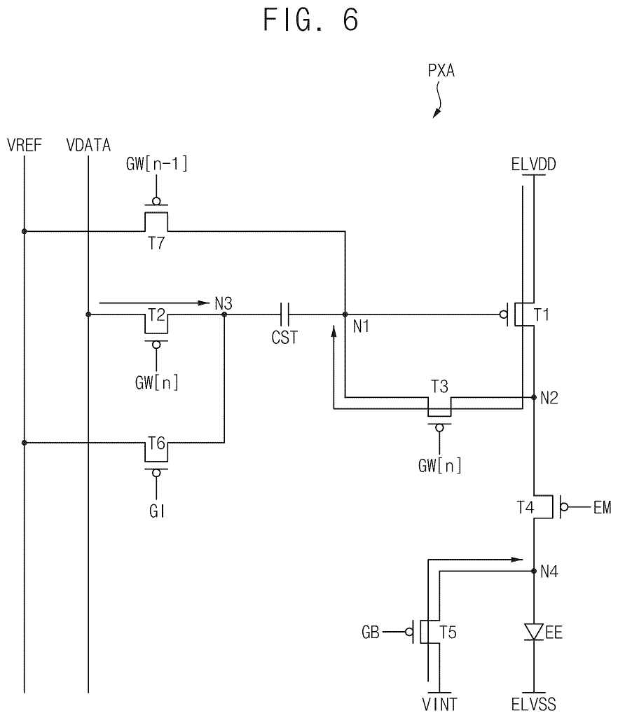

FIG. 6 is a circuit diagram illustrating an operation of a pixel circuit PXA of FIG. 3 in a second period TP2A of FIG. 4.

Referring to FIG. 4 and FIG. 6, in the second period TP2A, the second transistor T2 may be turned on in response to the write gate signal GW[n]. When the second transistor T2 is turned on, the data voltage VDATA may be applied to the third node N3.

In the second period TP2A, the third transistor T3 may be turned on in response to the write gate signal GW[n]. When the third transistor T3 is turned on, the first transistor T1 may be diode-connected. When the first transistor T1 is diode-connected, a voltage, which is a sum of the threshold voltage of the first transistor T1 and the first power voltage ELVDD, may be applied to the first node N1. For example, the sum of the threshold voltage of the first transistor T1 and the first power voltage ELVDD may be called as a compensation voltage. The storage capacitor CST may store a difference between the data voltage VDATA and the compensation voltage.

In an embodiment, the first electrode of the first transistor T1 may be a source electrode. Additionally, the data voltage VDATA may not be applied through the source electrode of the first transistor T1. The source electrode of the first transistor T1 may receive the first power voltage ELVDD. In an embodiment, for example, the source electrode of the first transistor T1 may only receive the first power voltage ELVDD. Accordingly, a voltage applied to the source electrode of the first transistor T1 may not be changed or maintained constant. The voltage applied to the source electrode of the first transistor T1 may not be changed, such that a change of the threshold voltage of the first transistor T1 by the body effect may not occur. Additionally, the threshold voltage of the first transistor T1 may be substantially constant during the frame period. Accordingly, the accuracy of the compensation voltage may be improved, such that the driving reliability and the emitting reliability may be further improved.

In the second period TP2A, a turn-on state of the fifth transistor T5 may be maintained in response to the bias gate signal GB having an inactivation level.

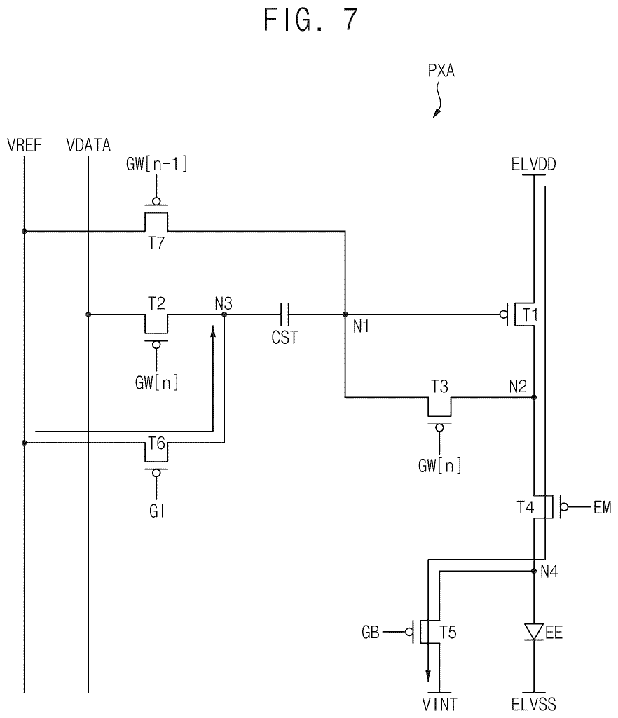

FIG. 7 is a circuit diagram illustrating an operation of a pixel circuit PXA of FIG. 3 in a third period TP3A of FIG. 4.

Referring to FIG. 4 and FIG. 7, in the third period TP3A, the sixth transistor T6 may be turned on in response to the initialization gate signal GI. When the sixth transistor T6 is turned on, the reference voltage VREF may be applied to the third node N3. In the third period TP3A, the third transistor T3 may be turned off in response to the write gate signal GW[n]. When the third transistor T3 is turned off, the first node N1 may be floating or in a floated state. The storage capacitor CST may be coupling a change of a voltage of the third node N3. The storage capacitor CST may be coupling the change of the voltage of the third node N3 and apply a coupling voltage to the first node N1. The coupling voltage may be applied to the first node N1, such that the first node N1 may have a voltage considering the compensation voltage and the data voltage VDATA.

In the third period TP3A, the first transistor T1 may generate the driving current based on a voltage of the first node N1.

In the third period TP3A, the fourth transistor T4 may be turned on in response to the emission signal EM. Additionally, the turn-on state of the fifth transistor T5 may be maintained in response to the bias gate signal GB. Accordingly, the light emitting element EE may not emit light.

In a conventional pixel circuit, the reliability of the current applied to the conventional light emitting element included in the conventional pixel circuit may be deteriorated by the parasitic capacitance of at least one of transistors included in the conventional pixel circuit in an emitting period. For example, when the conventional pixel circuit operates to display black, a current may be applied to the conventional light emitting element by the parasitic capacitance. Accordingly, the conventional light emitting element may emit light when the conventional pixel circuit operates to display black. When the conventional pixel circuit operates to display black, the conventional light emitting element may emit light, such that the display quality is reduced.

In an embodiment of the invention, the frame period during which the pixel circuit PXA is driven may include a third period TP3A. In the third period TP3A, a current may flow along a path through the first transistor T1, the fourth transistor T4 and the fifth transistor T5. Accordingly, the influence of the parasitic capacitance in the emitting period may be reduced. In an embodiment, for example, when the pixel circuit PXA operates to display black, the influence of the parasitic capacitance is reduced, such that the light emitting element EE may not emit light. Accordingly, the emitting reliability of the pixel circuit PXA may be improved. In such an embodiment, the emitting reliability of the pixel circuit PXA may be improved, such that the display quality of the display panel 100 may be improved.

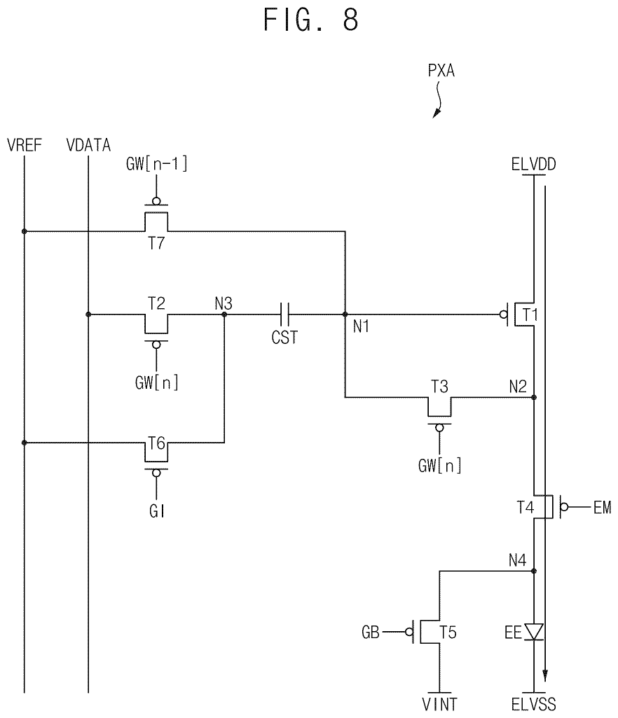

FIG. 8 is a circuit diagram illustrating an operation of a pixel circuit PXA of FIG. 3 in a fourth period TP4A of FIG. 4.

Referring to FIG. 4 and FIG. 8, in the fourth period TP4A, the fifth transistor T5 may be turned off in response to the bias gate signal GB. Accordingly, the driving current may be applied to the light emitting element EE. In the fourth period TP4A, the light emitting element EE may emit light based on the driving current.

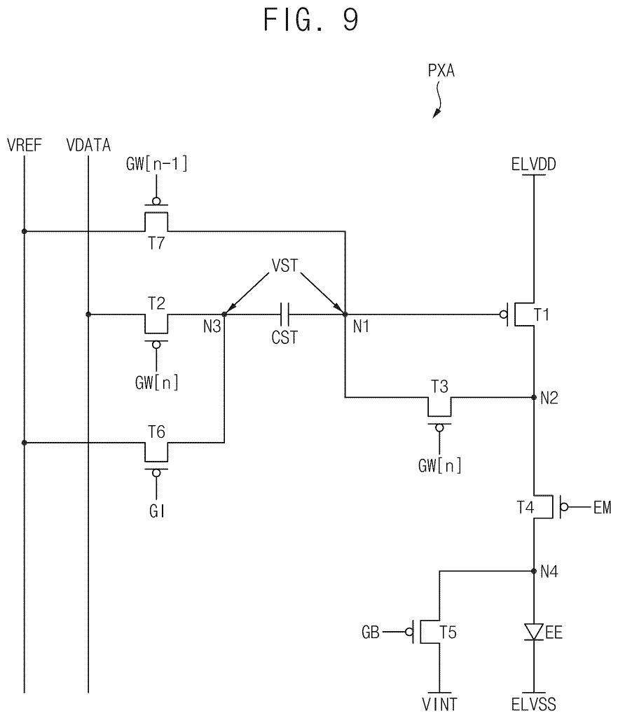

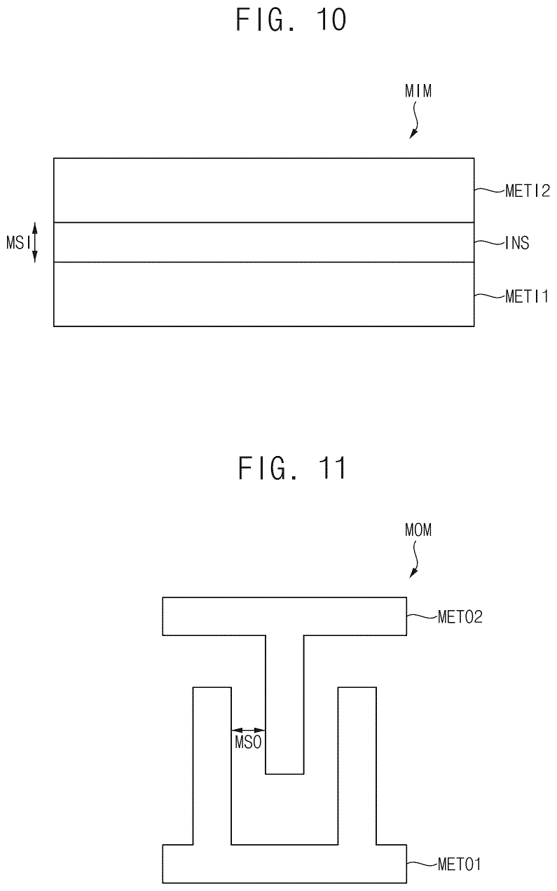

FIG. 9 is a circuit diagram illustrating an example of a pixel PXA included in a display apparatus 1 of FIG. 1. FIG. 10 is a schematic cross-sectional view of an example of a storage capacitor CST included in a pixel circuit PXA of FIG. 9.

Referring to FIG. 1, FIG. 9 and FIG. 10, the storage capacitor CST may include a first metal layer METI1, an insulating layer INS and a second metal layer METI2. The insulating layer INS may be disposed on the first metal layer METI1. The second metal layer METI2 may be disposed on the insulating layer INS. In an embodiment, for example, the storage capacitor CST may have a metal layer-insulating layer-metal layer structure.

In an embodiment, the reference voltage VREF may be higher than the first data voltage and lower than the K-th data voltage. In an embodiment, for example, the reference voltage VREF may have a value between the first data voltage and the K-th data voltage. In an embodiment, the value of the reference voltage VREF may have a median value between the first data voltage and the K-th data voltage. Accordingly, a storage voltage VST, which is the voltage between the first electrode and the second electrode of the storage capacitor CST, may be decreased. In such an embodiment, the storage voltage VST may be decreased, such that an insulating layer thickness MSI may be allowed to be thinner. In such an embodiment, the insulating layer thickness MSI may be thinner, such that an integration of the pixel circuit PXA may be improved. Accordingly, the pixel circuit PXA may be effectively applied to an ultra-high-resolution display apparatus.

FIG. 11 is a schematic plan view of an example of a storage capacitor CST included in a pixel circuit PXA of FIG. 9.

Referring to FIG. 1, FIG. 9 and FIG. 11, the storage capacitor CST may include a first metal pattern METO1 and a second metal pattern METO2. In an embodiment, for example, the storage capacitor CST may have a metal-oxide-metal structure.

In an embodiment, the reference voltage VREF may be higher than the first data voltage and lower than the K-th data voltage. In an embodiment, for example, the reference voltage VREF may have a value between the first data voltage and the K-th data voltage. In an embodiment, the value of the reference voltage VREF may have a median value between the first data voltage and the K-th data voltage. Accordingly, a storage voltage VST, which is the voltage between the first electrode and the second electrode of the storage capacitor CST, may be decreased. The storage voltage VST may be decreased, such that a metal pattern distance may be allowed to be shorter. The metal pattern distance may be shorter, such that an integration of the pixel circuit PXA may be improved. Accordingly, the pixel circuit PXA may be effectively applied to an ultra-high-resolution display apparatus.

FIG. 12 is a circuit diagram illustrating an example of a pixel circuit PX included in a display apparatus 1 of FIG. 1.

Referring to FIG. 12, an embodiment of a pixel circuit PXB may include the first transistor T1, the second transistor T2, the third transistor T3, the fourth transistor T4, the fifth transistor T5, the sixth transistor T6 and a seventh transistor T7B. The pixel circuit PXB is substantially the same as the pixel circuit PXA except that the seventh transistor T7B receives the control gate signal GR. Accordingly, the same reference numerals will be used for the same elements as those described above, and any repetitive detailed description thereof will be omitted.

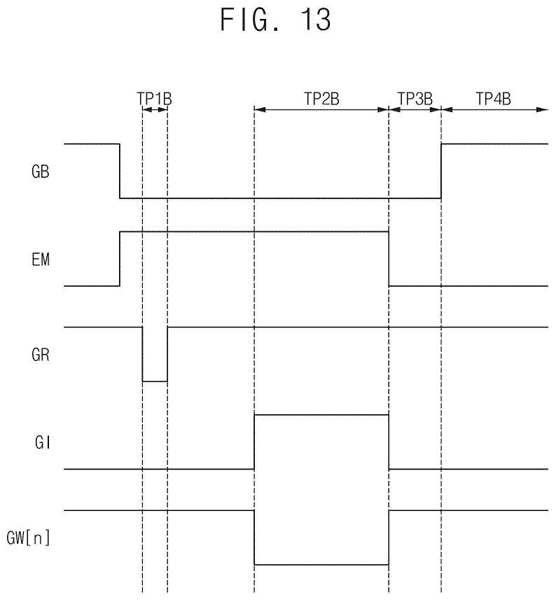

FIG. 13 is a signal timing diagram illustrating input signals applied to a pixel circuit PXB of FIG. 12.

Referring to FIG. 13, a frame period during which the pixel circuit PXB is driven may include a first period TP1B, a second period TP2B, a third period TP3B and a fourth period TP4B. The timing diagram of FIG. 13 is substantially the same as the timing diagram of FIG. 4 except for a length of the first period TP1B. Accordingly, the same reference numerals will be used for the same elements as those described above, and any repetitive detailed description thereof will be omitted.

Referring to FIG. 12 and FIG. 13, in the first period TP1B, the control gate signal GR may have an activation level. In the second period TP2B, the control gate signal GR may have an inactivation level. In the third period TP3B, the control gate signal GR may have an inactivation level. In the fourth period TP4B, the control gate signal GR may have an inactivation level.

In an embodiment, the frame period during which the pixel circuit PXB is driven may include a third period TP3B. In the third period TP3B, a current may flow along a path through the first transistor T1, the fourth transistor T4 and the fifth transistor T5. Accordingly, the influence of the parasitic capacitance in the emitting period may be reduced. In an embodiment, for example, when the pixel circuit PXB operates to display black, the influence of the parasitic capacitance is reduced, such that the light emitting element EE may not emit light. Accordingly, the emitting reliability of the pixel circuit PXB may be improved. In such an embodiment, the emitting reliability of the pixel circuit PXB may be improved, such that the display quality of the display panel 100 may be improved.

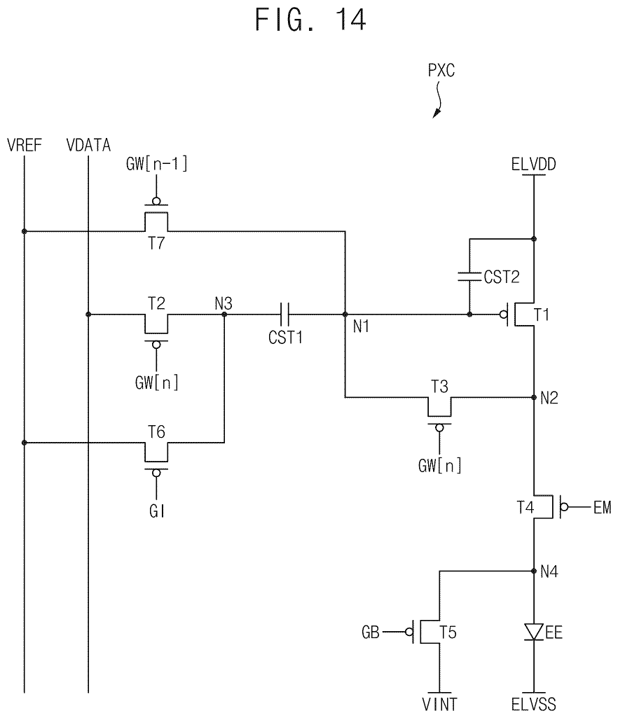

FIG. 14 is a circuit diagram illustrating an example of a pixel circuit PX included in a display apparatus 1 of FIG. 1.

Referring to FIG. 1 and FIG. 14, a pixel circuit PXC may include the first transistor T1, the second transistor T2, the third transistor T3, the fourth transistor T4, the fifth transistor T5, the sixth transistor T6 and a seventh transistor T7, a first storage capacitor CST1 and a second storage capacitor CST2. The pixel circuit PXB is substantially the same as the pixel circuit PXA except that the pixel circuit PXC further includes a second storage capacitor CST2. Accordingly, the same reference numerals will be used for the same elements as those described above, and any repetitive detailed description thereof will be omitted.

In an embodiment, the pixel circuit PXC may include the second storage capacitor CST2. A voltage of the first node N1 may be distributed to the first storage capacitor CST1 and the second storage capacitor CST2. Accordingly, a voltage load applied to the control electrode of the first transistor T1 may be reduced. In such an embodiment, the voltage load may be reduced, such that the stability of the first transistor T1 may be improved. Additionally, when the voltage load may be reduced, the voltage range of the first data voltage to the K-th data voltage may be wider.

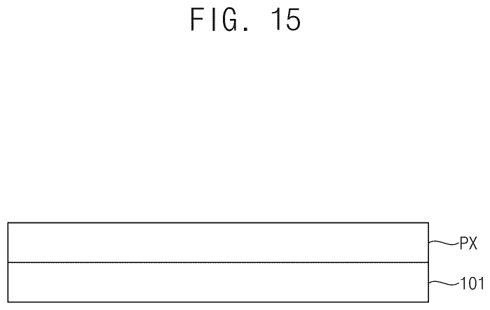

FIG. 15 is a diagram illustrating an example of pixel circuit PX of FIG. 1 disposed on a substrate 101.

Referring to FIG. 15, the pixel circuit PX may be disposed on a substrate 101. In an embodiment, the substrate 101 may be a silicon-based substrate. In an embodiment, the pixel circuit PX may be disposed on a silicon-based substrate. The pixel circuit PX may be disposed on a silicon-based substrate, the voltage levels of input signals applied to the pixel circuit PX may be set more precisely.

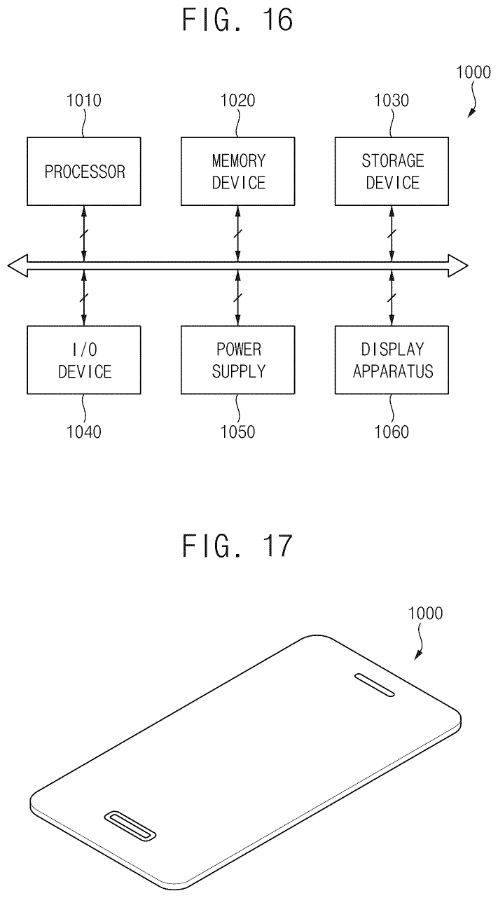

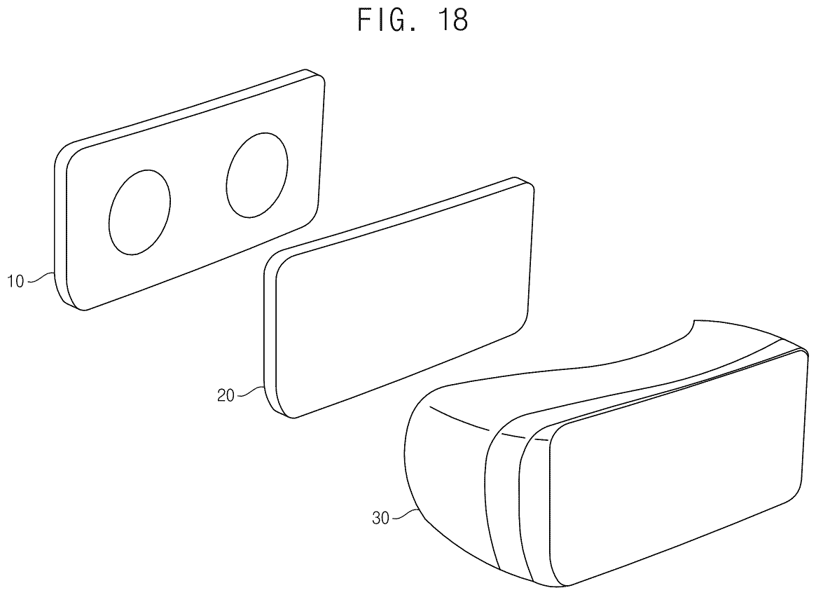

FIG. 16 is a block diagram illustrating an electronic device 1000 according to an embodiment of the invention. FIG. 17 is a diagram illustrating an example in which the electronic device of FIG. 16 is implemented as a smart phone.

Referring to FIG. 16, an embodiment of the electronic device 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. Additionally, the electronic device 1000 may further include a plurality of ports for communicating with a video card, a sound card, a memory card, a universal serial bus (USB) device, another electronic device, etc.

In an embodiment, as illustrated in FIG. 17, the electronic device 1000 may be implemented as a smart phone. However, the electronic device 1000 is not limited thereto. In an embodiment, for example, the electronic device 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 17, the electronic device of the invention is shown implemented as a smartphone, but the invention is not limited thereto. The electronic device may be a television, a monitor, a laptop computer, or a tablet. Additionally, the electronic device may be an element of a car.

FIG. 18 is a diagram illustrating an example in which the electronic apparatus of FIG. 16 is implemented as a virtual reality display system.

Referring to FIG. 16 and FIG. 18, in an embodiment of the electronic apparatus, which is implements as the virtual reality display system, may include a lens unit 10, a display apparatus 20 and a housing 30. The display apparatus 20 is disposed adjacent to the lens unit 10. The housing 30 may receive the lens unit 10 and the display apparatus 20. Although an embodiment where the lens unit 10 and the display apparatus 20 are received in a first side of the housing 30 is shown in FIG. 18, the invention may not be limited thereto. In another embodiment, the lens unit 10 may be received in a first side of the housing 30 and the display apparatus may be received in a second side of the housing 30. In an embodiment where the lens unit 10 and the display apparatus 20 are received in the housing 30 in opposite sides, the housing 30 may have a transmission area to transmit a light.

In an embodiment, for example, the virtual reality display system may be a head mounted display system which is wearable on a head of a user. Although not shown in figures, the head mounted display system may further include a head band to fix the virtual reality display system on the head of the user.

Alternatively, the virtual reality display system may have the form of smart glasses implemented in the shape of glasses.

Additionally, the electronic device may be implemented as an augmented reality display system, a mixed reality display system, or an extended reality display system.

The display apparatus according to the embodiments may be applied to a display apparatus included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel circuit comprising:
a first transistor which applies a driving current to a second node in response to a voltage of a first node;
a second transistor which applies a data voltage to a third node in response to a write gate signal;
a third transistor which connects the first node and the second node to each other in response to the write gate signal;
a fourth transistor which connects the second node and a fourth node to each other in response to an emission signal;
a fifth transistor which applies an initialization voltage to the fourth node in response to a bias gate signal;
a sixth transistor which applies a reference voltage to the third node in response to an initialization gate signal;
a seventh transistor which applies the reference voltage to the first node in response to a previous stage write gate signal;
a light emitting element including a first electrode connected to the fourth node and a second electrode which receives a second power voltage; and
a first storage capacitor including a first electrode connected to the third node and a second electrode connected to the first node.

2. The pixel circuit of claim 1, wherein the data voltage has one of first to K-th data voltages, wherein K is a positive integer, and
wherein a value of the reference voltage has a value between the first data voltage and the K-th data voltage.

3. The pixel circuit of claim 2, wherein the value of the reference voltage has a median value between the first data voltage and the K-th data voltage.

4. The pixel circuit of claim 1, wherein a frame period during which the pixel circuit is driven includes a data writing period, a holding period and an emitting period,
wherein in the data writing period, the write gate signal has an activation level,
wherein in the holding period, the emission signal has an activation level and the bias gate signal has an activation level, and
wherein in the emitting period, the emission signal has an activation level and the bias gate signal has an inactivation level.

5. The pixel circuit of claim 4, wherein in the holding period, the fourth transistor is turned on and the fifth transistor is turned on.

6. The pixel circuit of claim 5, wherein in a first period of the frame period during which the pixel circuit is driven, the previous stage write gate signal has an activation level, the initialization gate signal has an activation level, the sixth transistor is turned on and the seventh transistor is turned on.

7. The pixel circuit of claim 6, wherein in the first period, the bias gate signal has an activation level and the fifth transistor is turned on.

8. The pixel circuit of claim 6, wherein in a second period following the first period, the write gate signal has an activation level, and the second transistor and the third transistor are turned on.

9. The pixel circuit of claim 8, wherein in the second period, the activation level of the bias gate signal is maintained and a turn-on state of the fifth transistor is maintained.

10. The pixel circuit of claim 8, wherein in a third period following the second period, the initialization gate signal has an activation level and the sixth transistor is turned on.

11. The pixel circuit of claim 10, wherein in the third period, the bias gate signal has an activation level and the fifth transistor is turned on.

12. The pixel circuit of claim 10, wherein in a fourth period following the third period, the emission signal has an activation level, the bias gate signal has an activation level and the fifth transistor is turned off.

13. The pixel circuit of claim 1, further comprising a second storage capacitor,
wherein the first transistor includes a control electrode connected to the first node, a first electrode which receives a first power voltage and a second electrode connected to the second node, and
wherein the second storage capacitor includes a first electrode connected to the first node and a second electrode which receives the first power voltage.

14. The pixel circuit of claim 1, wherein the first transistor includes a control electrode connected to the first node, a first electrode which receives a first power voltage and a second electrode connected to the second node,
wherein the second transistor includes a control electrode which receives the write gate signal, a first electrode which receives the data voltage and a second electrode connected to the third node,
wherein the third transistor includes a control electrode which receives the write gate signal, a first electrode connected to the second node and the second electrode connected to the first node,
wherein the fourth transistor includes a control electrode which receives the emission signal, a first electrode connected to the second node and a second electrode connected to the fourth node,
wherein the fifth transistor includes a control electrode which receives the bias gate signal, a first electrode connected to the fourth node and a second electrode which receives the initialization voltage,
wherein the sixth transistor includes a control electrode which receives the initialization gate signal, a first electrode which receives the reference voltage and a second electrode connected to the third node, and
wherein the seventh transistor includes a control electrode which receives the previous stage write gate signal, a first electrode which receives the reference voltage and a second electrode connected to the first node.

15. A pixel circuit comprising:
a first transistor which applies a driving current to a second node in response to a voltage of a first node;
a second transistor which applies a data voltage to a third node in response to a write gate signal;
a third transistor which connects the first node and the second node to each other in response to the write gate signal;
a fourth transistor which connects the second node and a fourth node to each other in response to an emission signal;
a fifth transistor which applies an initialization voltage to the fourth node in response to a bias gate signal;
a sixth transistor which applies a reference voltage to the third node in response to an initialization gate signal;
a seventh transistor which applies the reference voltage to the first node in response to a control gate signal;
a light emitting element including a first electrode connected to the fourth node and a second electrode which receives a second power voltage; and
a first storage capacitor including a first electrode connected to the third node and a second electrode connected to the first node.

16. The pixel circuit of claim 15, wherein the data voltage has one of first to K-th data voltages, wherein K is a positive integer, and
wherein a value of the reference voltage has a value between the first data voltage and the K-th data voltage.

17. The pixel circuit of claim 16, wherein the value of the reference voltage has a median value between the first data voltage and the K-th data voltage.

18. The pixel circuit of claim 15, wherein a frame period during which the pixel circuit is driven includes a data writing period, a holding period and an emitting period,
wherein in the data writing period, the write gate signal has an activation level,
wherein in the holding period, the emission signal has an activation level and the bias gate signal has an activation level, and
wherein in the emitting period, the emission signal has an activation level and the bias gate signal has an inactivation level.

19. A display apparatus comprising:
a display panel including a pixel circuit;
a gate driver which outputs a write gate signal, a previous stage write gate signal, an initialization gate signal and a bias gate signal to the pixel circuit;
a data driver which applies a data voltage to the display panel; and
an emission driver which applies an emission signal to the pixel circuit,
wherein the pixel circuit includes:
a first transistor which applies a driving current to a second node in response to a voltage of a first node;
a second transistor which applies a data voltage to a third node in response to a write gate signal;
a third transistor which connects the first node and the second node to each other in response to the write gate signal;
a fourth transistor which connects the second node and a fourth node to each other in response to an emission signal;
a fifth transistor which applies an initialization voltage to the fourth node in response to a bias gate signal;
a sixth transistor which applies a reference voltage to the third node in response to an initialization gate signal;
a seventh transistor which applies the reference voltage to the first node in response to a previous stage write gate signal;
a light emitting element including a first electrode connected to the fourth node and a second electrode which receives a second power voltage; and
a first storage capacitor including a first electrode connected to the third node and a second electrode connected to the first node.

20. The display apparatus of claim 19, wherein the data voltage has one of first to K-th data voltages, wherein K is a positive integer, and
wherein a value of the reference voltage has a value between the first data voltage and the K-th data voltage.

21. The display apparatus of claim 20, wherein the value of the reference voltage has a median value between the first data voltage and the K-th data voltage.

22. The display apparatus of claim 19, wherein a frame period during which the pixel circuit is driven includes a data writing period, a holding period and an emitting period,
wherein in the data writing period, the write gate signal has an activation level,
wherein in the holding period, the emission signal has an activation level and the bias gate signal has an activation level, and
wherein in the emitting period, the emission signal has an activation level and the bias gate signal has an inactivation level.

23. The display apparatus of claim 19, wherein a frame period during which the pixel circuit is driven includes a first period, a second period, a third period and a fourth period,
wherein in the first period, the bias gate signal has an activation level, the emission signal has an inactivation level, the previous stage write gate signal has an activation level, the initialization gate signal has an activation level and the write gate signal has an inactivation level,
wherein in the second period, the bias gate signal has an activation level, the emission signal has an inactivation level, the previous stage write gate signal has an inactivation level, the initialization gate signal has an inactivation level and the write gate signal has an activation level,
wherein in the third period, the bias gate signal has an activation level, the emission signal has an activation level, the previous stage write gate signal has an inactivation level, the initialization gate signal has an activation level and the write gate signal has an inactivation level, and
wherein in the fourth period, the bias gate signal has an inactivation level, the emission signal has an activation level, the previous stage write gate signal has an inactivation level, the initialization gate signal has an activation level and the write gate signal has an inactivation level.

24. The display apparatus of claim 19, wherein the pixel circuit is disposed on a silicon-based substrate.

25. An electronic apparatus comprising:
a display panel including a pixel circuit;
a gate driver which outputs a write gate signal, a previous stage write gate signal, an initialization gate signal and a bias gate signal to the pixel circuit;
a data driver which applies a data voltage to the display panel;
an emission driver which applies an emission signal to the pixel circuit;
a driving controller which controls the gate driver the data driver and the emission driver based on an input control signal; and
a processor which outputs the output control signal to the driving controller,
wherein the pixel circuit includes:
a first transistor which applies a driving current to a second node in response to a voltage of a first node;
a second transistor which applies a data voltage to a third node in response to a write gate signal;
a third transistor which connects the first node and the second node to each other in response to the write gate signal;
a fourth transistor which connects the second node and a fourth node to each other in response to an emission signal;
a fifth transistor which applies an initialization voltage to the fourth node in response to a bias gate signal;
a sixth transistor which applies a reference voltage to the third node in response to an initialization gate signal;
a seventh transistor which applies the reference voltage to the first node in response to a previous stage write gate signal;
a light emitting element including a first electrode connected to the fourth node and a second electrode which receives a second power voltage; and
a first storage capacitor including a first electrode connected to the third node and a second electrode connected to the first node.
